(19) United States
(12) Patent Application Publication
(10) Pub. No.: US 2007/0155415 A1
(43) Pub. Date: Jul. 5, 2007

(54) Push-to-talk (PTT) voice log method

(76) Inventors: Rosemary Sheehy, Hillsborough, NJ (US); Nicholas C. Chiarulli, Manchester, NJ (US)

Correspondence Address: MOTOROLA INC, 600 NORTH US HIGHWAY 45, ROOM AS437, LIBERTYVILLE, IL, 60048-5343, US

(21) Appl. No.: 11/323,238

(22) Filed: Dec. 30, 2005

(51) Int. Cl. H04B 7/00; H04Q 7/20

(52) U.S. Cl. 455/518

(57) ABSTRACT

A push-to-talk voice log method is disclosed. The method includes designating group members for a push-to-talk group call (302); implementing a push-to-talk group call between at least two of the group members (304); recording the push-to-talk group call (306); record metadata associated with PTT group call (308); notify available and unavailable members of PTT group call which took place (314); and playing back the push-to-talk group call (316).

### FIELD OF THE INVENTION

The present invention relates generally to push-to-talk (PTT) communication systems. More particularly, the present invention relates to recording of a PTT group call and rendering the recorded PTT group call available for playback to group participants.

### BACKGROUND

Push-To-Talk (PTT) is a two-way communication service that is half-duplex; meaning communication can only travel in one direction at any given moment. To control which person can speak and be heard, PTT generally requires the person speaking to press a button on his device before and while talking and then release it when he is done. The listener then pushes a PTT button on her device to respond. Calls can be initiated to both individuals and talk groups.

A conventional push-to-talk (PTT) communication system utilizes multiple PTT-capable transceiver devices tuned to a common communication channel. A participant in a PTT group call pushes a button on his or her transceiver device to transmit an audio voice message to another participant or participants in the group, which voice message is typically simultaneously heard by the other group participant or participants on their transceiver devices. The participant releases the button on the device and may receive an audio voice message from any or each of the other group participants. The PTT communication system typically includes the capability to determine the priority in which the participants in the PTT group are allowed to transmit their voice messages to the other participants.

A Session Initiated Protocol (SIP) based PTT group call utilizes a list of contacts or group members which is stored on the PTT transceiver device of each of the members of a PTT group. Each member of the PTT group can initiate a conversation with any of the other members of the group on the list.

Typically, no record of a PTT group call is available to the PTT group call participants. This is particularly disadvantageous for those members of the group who were unable to participate in the call. Furthermore, in the event that a participant's connection is inadvertently lost during a PTT group call and the conversation among the remaining participants continues, she may be deprived of access to important information, which was exchanged among the other group participants during the disconnection time period. Moreover, with conventional technology, if a participant desires to recall important information that was exchanged among participants during a call, no record of the call is available for her to review in order to retrieve the information.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a PTT communication system in accordance with some embodiments.

FIG. 2 is an example of a PTTVL contact of a PTT communication system in accordance with some embodiments.

FIG. 3 is an example of a PTT voice log method in accordance with some embodiments.

FIG. 4 is a schematic block diagram illustrating recording and posting of a portion of a PTT group call in accordance with some embodiments.

FIG. 5 is a schematic block diagram illustrating playback of a recorded portion of a PTT group call in accordance with some embodiments.

FIG. 6 is a flow diagram illustrating a typical PTT group call scenario and engagement of a handset, PTT server and PTTVL contact of a PTT communication system in accordance with some embodiments.

### DETAILED DESCRIPTION

Before describing in detail embodiments that are in accordance with the present invention, it should be observed that the embodiments reside primarily in combinations of method steps and apparatus components related to a PTT voice log method. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a PTT voice log method described herein. The non-processor circuits may include, but are not limited to, a radio receiver, a radio transmitter, signal drivers, clock circuits, power source circuits, and user input devices. As such, these functions may be interpreted as steps of a method to perform the logging or recording of a PTT group call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Illustrative embodiments in accordance with the invention include a Push-To-Talk (PTT) voice log method, which includes recording individual elements of a PTT group call and selectively playing back the PTT group call elements to at least one group participant or member. The method enables group members, particularly those who were unavailable during the PTT group call, to subsequently access and play back an audio record of the call. During a PTT group call, the information exchanged among group participants, in addition to audio, may include media formats such as pictures, video, pre-recorded audio, and documents, in non-exclusive particular. The information can be exchanged and discussed among the group participants while the PTT session is ongoing. All information can be recorded and stored for later playback of the PTT group call. The method also enables group participants who took part in the call to review information exchanged among participants during the call, by playing back a record of the call. The call may be recorded with metadata or other indexing information to facilitate a rich playback experience to group participants or members.

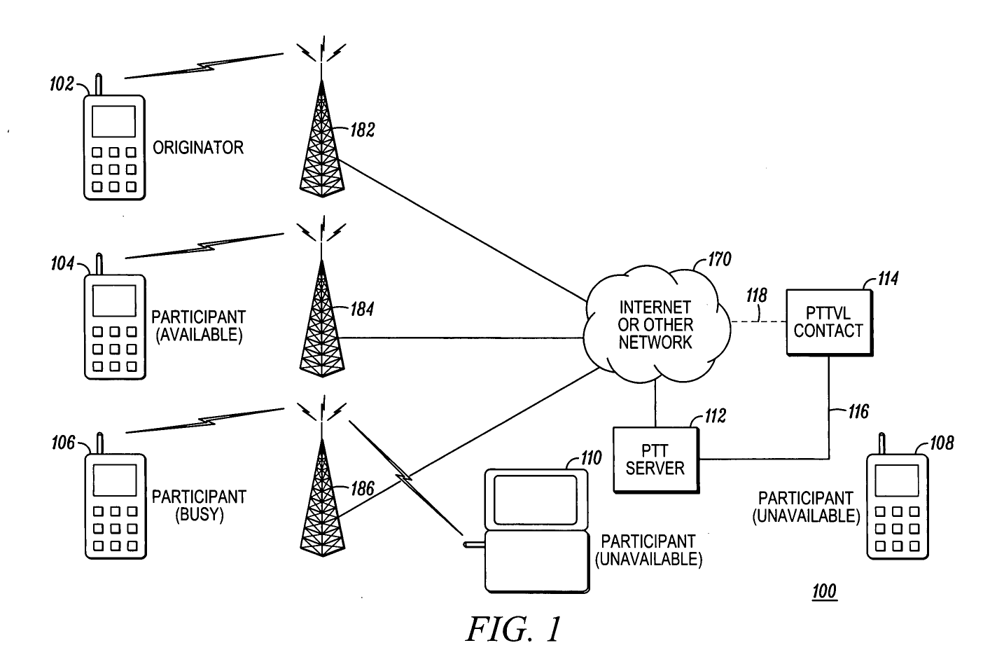

Referring initially to FIG. 1, an example of a PTT communication system in implementation of some embodiments is generally indicated by reference numeral 100. The example shown in FIG. 1 is a generic PTT communication system, and it is understood that the example can be converted to a PTT-over-Cellular (PoC) communication system or another specific type of communication system with PTT features. The PTT communication system 100 includes a PTT communication device 102, which is used by an originator who initiates a PTT group call, as will be hereinafter described. The PTT communication device 102 has a wireless connection to a base station 182, which is in communication with an Internet, Intranet, or other type of network 170. The PTT communication system 100 further includes a PTT communication device 104, which is used by a participant in the PTT group call. In this embodiment, the PTT communication device 104 is in communication with another base station 184. The PTT group call may be a person-to-person PTT group call having two participants, in which case the PTT communication system 100 includes the PTT communication devices 102 and 104. Alternatively, the PTT group call may include more than two participants, in which case the PTT communication system 100 includes additional PTT communication devices, such as PTT communication devices 106 and 108, the quantity of which depends on the number of additional participants taking part in the PTT group call. The PTT communication device 106 is wirelessly connected to a third base station 186 but is on another call, while the PTT communication device 108 is not connected to any base station and thus is unavailable. The PTT communication devices 102, 104, 106 and 108 of the PTT communication system 100 may be mobile telephones or any other type of device having PTT communication capability, including, for example, a PTT-capable networked computer 110 wirelessly connected to the base station 186.

Generally, the PTT communication devices each include: a speaker (not shown); a microphone (not shown); a micro-browser or micro-client software application (not shown) having an Internet, Intranet or Extranet address; and a real or virtual push-to-talk (PTT) button (not shown). Each of the PTT communication devices has the capability, responsive to depression of the PTT button, to convert a voice message, spoken by a participant into the microphone, into a streaming voice data message (SVDM) and transmit the SVDM to a PTT server 112, as will be hereinafter further described. PTT communication devices may further include an indication that the PTT button on the device has been depressed. Each of the PTT communication devices also includes the capability to receive an SVDM from the PTT server 112 when the PTT button is in a released configuration. Some of the PTT communication devices may also have to capability to send and receive other types of messages using the PTT system, such as pictures, video, pre-recorded files, and text.

The PTT communication devices of the PTT communication system 100 further include features, or capabilities, that facilitate interaction of the PTT communication device with the PTT Voice Log (PTTVL) contact 114, during implementation of some embodiments of the PTT voice log method. These include, for example, the capability to receive, from the PTTVL contact 114, an indication that a PTT group call previously took place, as well as an indication of the recorded PTT group call availability for audio review. The PTT communication devices further include the capability to bring these indications to the attention of the participant, such as by displaying the indication on a display, for example, provided on the PTT communication device. Furthermore, each PTT communication device shown has the capability to transmit a playback request to the PTTVL contact 114, to receive a recorded PTT group call from the PTTVL contact 114, and to broadcast the recorded PTT group call through the speaker of the PTT communication device. Each PTT communication device shown may also include the capability to receive, from the PTTVL contact 114, audio or non-audio messages, along with the capability to display or otherwise indicate the speaker or other metadata of each message in the recorded PTT group call during playback of the call.

The PTT server 112 of the PTT communication system 100 may be, for example, an Internet server, an Intranet server or an Extranet server. The PTT server 112 has the capability to store multiple Internet, Intranet or Extranet addresses of PTT communication devices which are used by group members who are to take part in a PTT group call, as well as the facility to add and subtract addresses for the inclusion or exclusion, respectively, of PTT communication devices in a PTT group call. The PTT server 112 includes the capability to receive an indication that a PTT button (not shown) on a PTT communication device in the PTT communication system 100 has been depressed at any of the Internet, Intranet or Extranet addresses stored in the PTT server 112. When the user presses the PTT button the user is requesting floor control. If the floor is granted then the user can speak, otherwise they are rejected and have to wait until the floor control has been released.

The PTTVL contact 114 of the PTT communication system 100 facilitates the voice log recording and playback functions of the PTT communication system 100. The PTTVL contact 114 may be integrated into the PTT server 112. Alternatively, the PTTVL contact 114 may function as a standalone server or it may be a PTT client application running on a personal computer (PC) in the PTT communication system 100. In those cases, the PTTVL contact 114 communicates with the PTT server 112 through a suitable server interface 116. Optionally, the PTTVL contact 114 can have an additional interface 118 directly to the network 170 (instead of, or in addition to, an indirect connection to the network 170 through PTT server 112), which is useful for playback of recorded portions of PTT group calls.

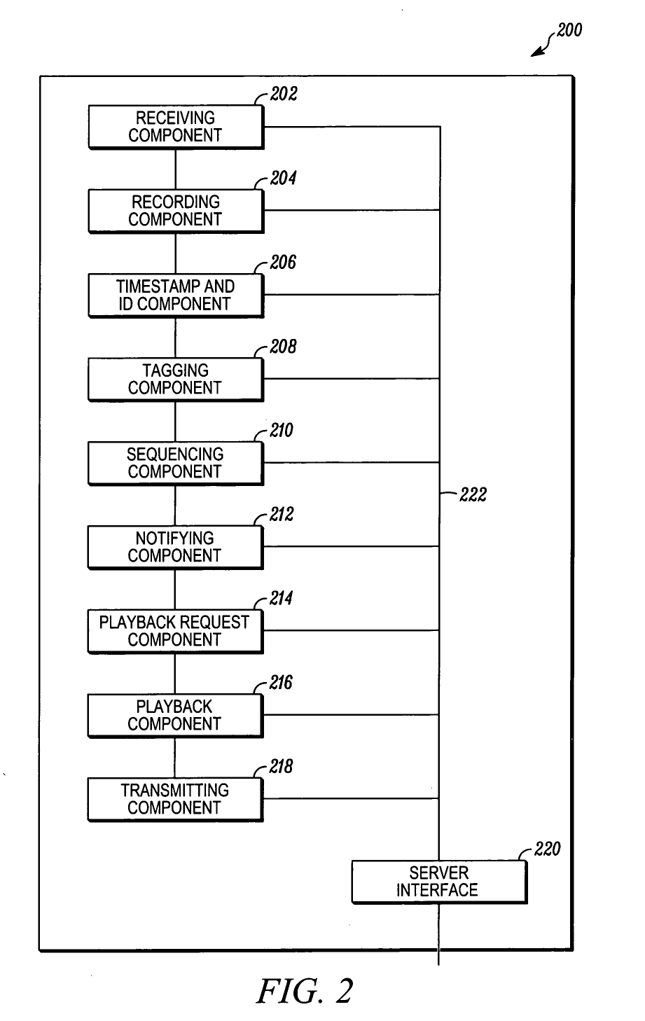

Referring next to FIG. 2, an example of a PTTVL contact 200 of a PTT communications system in implementation of some embodiments is shown. The implementation shown assumes that the components are software components (e.g., routines, subroutines, etc.). The components, however, may alternately be implemented using hardware, firmware, or combinations of software, hardware, and firmware. The PTTVL contact 200 may have a configuration as described above with respect to the PTTVL contact 114 of FIG. 1 and include a receiving component 202 capable of receiving one or more SVDM(s) or other types of messages from each PTT communication device in the PTT communication system. In some embodiments, the receiving component 202 of the PTTVL contact 200 is capable of receiving messages for multiple PTT group calls simultaneously, in which case the PTTVL contact 200 is capable of handling multiple simultaneous group calls. A recording component 204 is capable of recording each SVDM or other type of message. The recording component 204 has the capability to individually record each SVDM from the PTT communication devices of the participants of a PTT group call as an audio clip typically in a line-by-line format. However, other media formats other than audio formats may be transferred and recorded by the recording component 204 during a PTT group call. These media formats may include but are not limited to pictures, video, pre-recorded audio, and documents. A timestamp and ID component 206 of the PTTVL contact 200 has the capability to identify each recording of a message received from the PTT communication devices. The timestamp and ID component 206 may identify each audio clip by such timestamp information as the time and date of the transmission of the corresponding SVDM and such ID information as the name and phone number, for example, of a participant who produced the message corresponding to the recording.

A tagging component 208 of the PTTVL contact 200 has the capability to tag each of the recordings from the participants in the PTT group call with the timestamp and ID information. A sequencing component 210 of the PTTVL contact 200 has the capability to sequence the recordings, typically in chronological order, into the recorded PTT group call. A notifying component 212 of the PTTVL contact 200 has the capability to notify PTT group members who were unavailable during the PTT group call that the PTT group call has taken place and that the recorded PTT group call is available to the members for playback, typically via the member's PTT communication device. The notifying component 212 may also include the capability to notify the participants of the PTT group call that the recorded PTT group call is available for playback. A playback request component 214 of the PTTVL contact 200 has the capability to receive playback requests from a PTT group member typically using his or her PTT communication device. A playback component 216 of the PTTVL contact 200 includes the capability to play back the recorded PTT group call to group members choosing to play back portions of the PTT group call on the group members' PTT communication devices. The PTTVL contact 200 further includes a transmitting component 218 which is capable of transmitting portions of the recorded PTT group call to the PTT communication device of each requesting group member, typically, in the form of audio messages with textual metadata that can be converted by the device using a text-to-speech feature. Another method of transmitting the recorded PTT group call to the PTT communication device of each requesting group member would typically be to send the proper messages to the device to simulate the recorded audio volley with a display of the metadata to indicate which speaker's recording is currently being heard.

The PTTVL contact 200 may also include a server interface 220, which interfaces with the PTT server 112 of the PTT communication system 100 shown in FIG. 1. The server interface 220 has the capability to transmit one or more recorded SVDM(s) or other messages, received from each PTT communication device through the receiving component 202, to the PTT server 112 for subsequent transmission to PTT communication devices requesting playback. Furthermore or alternately, the PTTVL contact 200 may include an interface (not shown) to facilitate transmission of recorded messages to the PTT communication devices without using the PTT server such as through interface 118 shown in FIG. 1. The various functional components of the PTTVL contact 200 may be connected to each other and to the server interface 220 by a bus 222 or other suitable architecture.

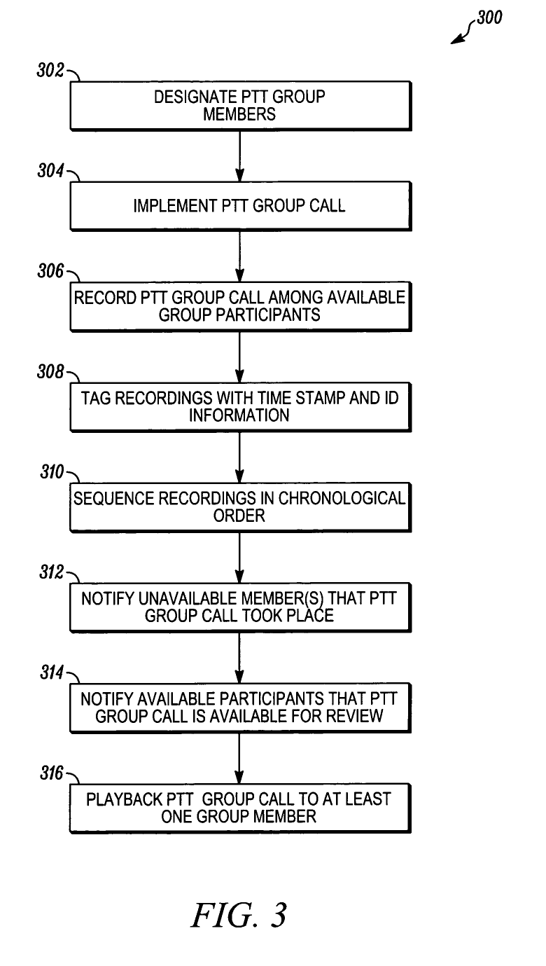

Referring to the flow diagram 300 of FIG. 3 in conjunction with FIG. 1, implementation of the PTT voice log method according to some embodiments is as follows. Referring to step 302 of FIG. 1, the members of a PTT group are designated. This step is typically carried out by entering or storing the Internet, Intranet, or Extranet addresses of the PTT communication devices, for all of the PTT group members designated to participate in a PTT group call, into the PTT communication device of each of the PTT group members. The Internet, Intranet, or Extranet address of the PTT communication device of each PTT group member is also typically stored in the PTT server 112. In some embodiments, a Group List Management System (GLMS) handles the PTT group member list and the PTT server 112 handles the media traffic during a PTT group call.

Referring to step 304 of FIG. 3, the PTT group call is initiated by an originator having the PTT communication device 102, and then implemented among the available participants of the PTT group. The participants in the PTT group call may include the originator, via the originator's PTT communication device 102, as well as a second participant using the PTT communication device 104. The participants in the PTT group call may also include any additional members of the PTT group, including the available participant using PTT communication device 110. For purposes of illustration herein, the only PTT group members who are participants in an illustrative group call are the originator, using PTT communication device 102, and one additional participant using PTT communication device 104. For this illustration, the intended participants of the PTT group members using PTT communication devices 106, 108 and 110 are unavailable when the originator wishes to initiate the PTT Group call in this example and, therefore, do not take part in the PTT group call.

Throughout the PTT group call, each participant in the call is capable of individually transmitting voice and other messages to the other call participant. Each participant transmits a voice message to the other participant typically by depressing the PTT button (not shown) on his or her PTT communication device and talking into the microphone (not shown) of the device. The voice message of each participant is converted into a streaming voice data message (SVDM), which is transmitted to the PTT server 112. After one participant places a SVDM on the PTT server 112, typically by speaking while depressing the PTT button on his or her PTT communication device, the other participant is able to receive the SVDM from the PTT server 112, with the PTT button of her PTT communication device in the released position. The PTT server 112 typically has the capability of prioritizing placement of the messages from multiple PTT communication devices thereon for transmission to the other PTT communication devices, in order to provide an orderly conversational sequence among the participants in the group.

Generally, steps 306, 308, 310, 312, 314, 316 of the method are carried out by the PTTVL contact 114 of the PTT communication system 100. Referring to step 306, the PTT group call, implemented by the participants, is recorded. Each voice message or conversational burst from each of the participants is recorded as a separate audio clip, which may be recorded with metadata to enhance the playback quality of the audio clips. A benefit of this implementation is that unwanted ambient noise during silent periods throughout the recordings is eliminated, because only the individual voice link conversational bursts are recorded using appropriate uplink audio control. Half duplex recording produces clear recordings by preventing other participants from “talking over” a speaker. As mentioned earlier, non-voice messages transmitted by a participant can also be recorded by the PTTVL contact 114.

Referring to step 308, the recordings are tagged with timestamp and ID information. The timestamp information may include such information as the time and/or date of the recording of each clip. The ID information may include such information as the name and/or phone number, for example, of the participant who produced the message. In step 310, the messages from the participants are sequenced typically in chronological order.

Referring to step 312, at the conclusion of the PTT group call, the PTTVL contact 114 may notify the PTT group members who were unavailable during the group call that the group call took place and is available for playback. Accordingly, the PTTVL contact 114 typically transmits an appropriate data signal to the PTT communication devices 106, 108 and 110 of the unavailable group members. Examples of the data signal include: a short message service (SMS) message with a link to an internet site storing the recording, an automated voicemail message with directions to access the recording, a new contact in a contact list that contains a connection to the recording, and a multimedia message (MMS) with one or more of the recordings as payload. The notification that the group call took place and is available for playback may appear on a display (not shown) provided on the PTT communication devices 106, 108 and 110, or may be brought to the attention of the unavailable group members in an additional or alternative manner, including, for example, via an audible means. Furthermore, the notification to the remaining unavailable group members may take place when one of the unavailable group members accesses the PTTVL contact 114 for playback of the missed PTT group call.

In step 314, the PTTVL contact 114 may notify the PTT group members who were able to participate in the group call that the call is available for playback, typically by transmitting an appropriate data signal to the PTT communication devices 102 and 104 of the participants in the group call. The notification that the recorded group call is available for playback may appear on a display (not shown) provided on the PTT communication devices 102 and 104, or may be brought to the attention of the group call participants, again, by alternative or additional notification means.

Referring to step 316, at least one group member plays back at least a portion of the recorded PTT group call typically on his or her PTT communication device. This may be accomplished by, for example, initially transmitting a playback request from the PTT communication device to the PTTVL contact 114. In response, the PTTVL contact 114 transmits the recorded PTT group call from the PTTVL contact 114 to the PTT communication device, typically as a series of audio messages streamed with textual metadata associated with each audio message. All or a portion of the textual metadata can be displayed on a display of the device. Alternately or additionally, the textual metadata can be converted to speech using a text-to-speech feature of the device. The PTT communication device plays the audio clips of the recorded PTT group call line-by-line through the speaker of the PTT communication device and displays non-audio messages and metadata on the display of the PTT communication device. As the audio clips of all the participants in the PTT group call are sequentially broadcasted from the speaker of the PTT communication device, typically according to the chronological order of the participants' voice messages in the PTT group call, the timestamp and ID information associated with each video clip are displayed and/or otherwise indicated on the PTT communication device of the group member. For example, the timestamp and ID information displayed or otherwise indicated on the PTT communication device may include such information as the name and/or telephone number of the participant who created the message, and the recording time and/or date of the audio, video, or textual clip. The group member may play back the entire recorded PTT group call or a portion of the recorded PTT group call as often as desired or necessary for the group member to obtain information exchanged by participants during the call.

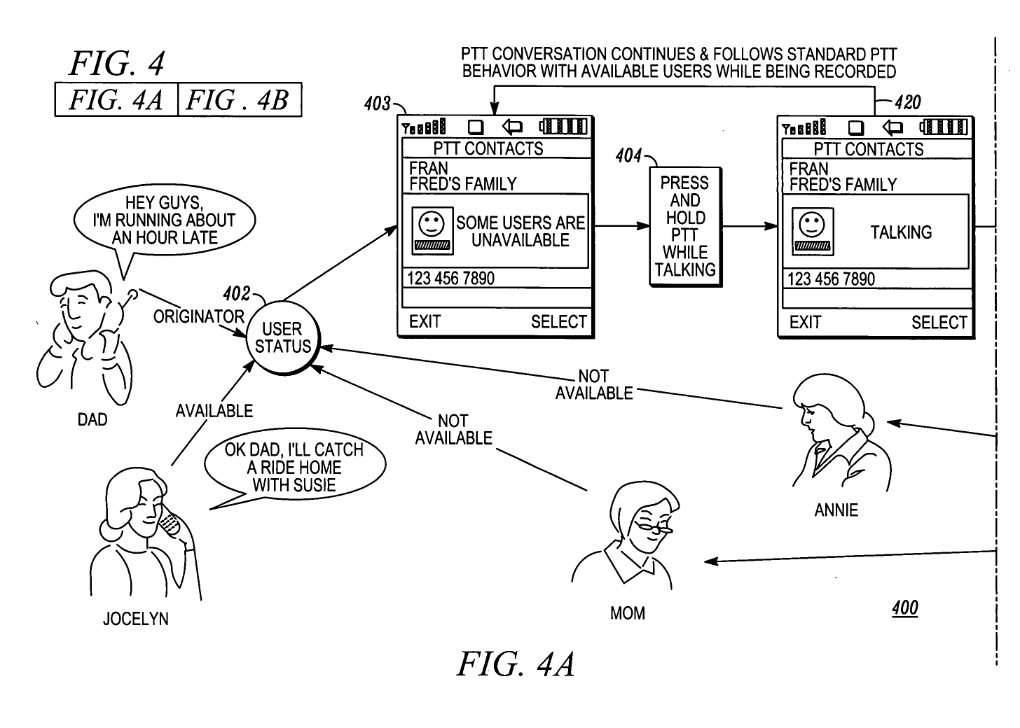

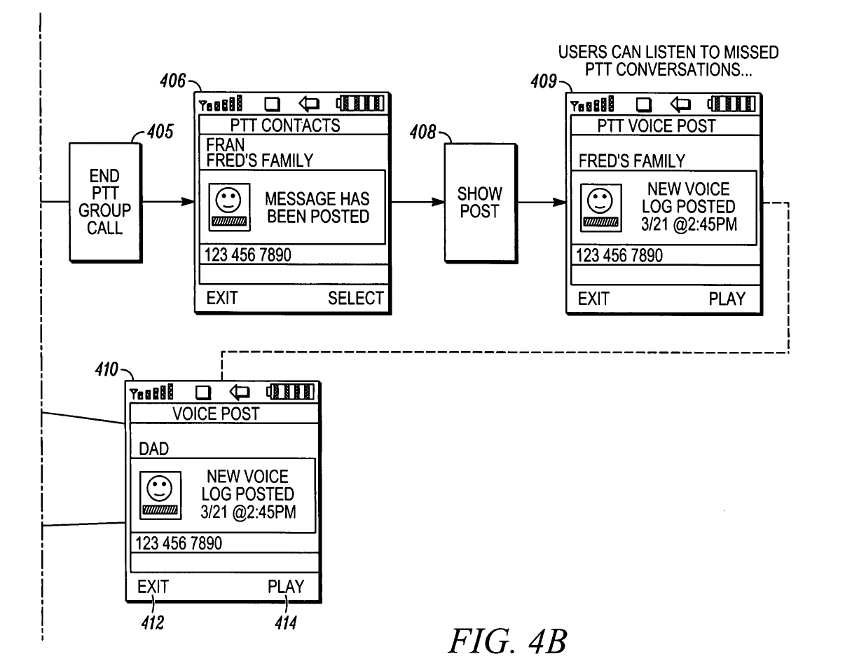

A schematic block diagram 400 illustrating recording and posting of a portion of a PTT group call in accordance with some embodiments is illustrated in FIG. 4. For purposes of illustration, the PTT group call implemented in FIG. 4 has four participants who are members of a family (Fred's Family): Dad, Jocelyn, Annie and Mom. Accordingly, a PTT group call participant, labeled “Dad” in FIG. 4, initially engages his PTT device to participate in a PTT group call in FIG. 4 Upon initiation of the PTT group call, in step 402 Dad's PTT device indicates that Jocelyn is available but Annie and Mom are not available. Dad's PTT device may indicate 403 this in a visual format, such as by textually displaying “Some users are unavailable” or specifying which participants are available/not available, or may indicate it audibly, or both visually and audibly. In step 404, Dad presses the PTT button on his PTT device, successfully retrieves the floor, and speaks to the PTT device. For example, Dad may speak a message such as, “Hey guys, I'm running about an hour late” into the PTT device. Simultaneously, the message is recorded by the PTTVL contact of the PTT communication system as well as transmitted to the available participants. After Dad speaks into his PTT device and releases his PTT button, the PTT conversation among other PTT group participants may continue as shown by feedback loop 420. In this example, available participant Jocelyn responds by pressing her PTT button and stating “OK dad, I'll catch a ride home with Susie.”

Upon conclusion 405 of the PTT group call, a message which indicates recording and posting of Dad's and Jocelyn's conversation may appear 406 on Dad's and/or Jocelyn's PTT device. For example, a visual message, such as “Message has been Posted” in a textual format, may appear on Dad's and Jocelyn's PTT device. However, the recording and posting message may be indicated by other formats including visual, textual, or both visual and textual formats. In step 408, the posting of the complete PTT Voice Log of the PTT group call may be displayed 409 on Dad's PTT device as well as Jocelyn's PTT device. This may be done by textually displaying the time and date of the voice log post, such as “New Voice Log Posted 3/21 @2:45 pm”, for example. Alternatively, displaying of the voice log post may be carried out audibly, or both visually and audibly. In step 410, the complete PTT voice log post can be indicated on the PTT devices of other intended but unavailable PTT group participants visually, audibly, or both visually and audibly. For example, Annie's and Mom's PTT devices may indicate the availability of Dad's and Jocelyn's recorded messages textually, such as by displaying “New Voice Log Posted 3/21 @ 2:45 pm”, for example. The PTT device typically further includes the option to exit 412 the PTT contacts option or play 414 the posted message.

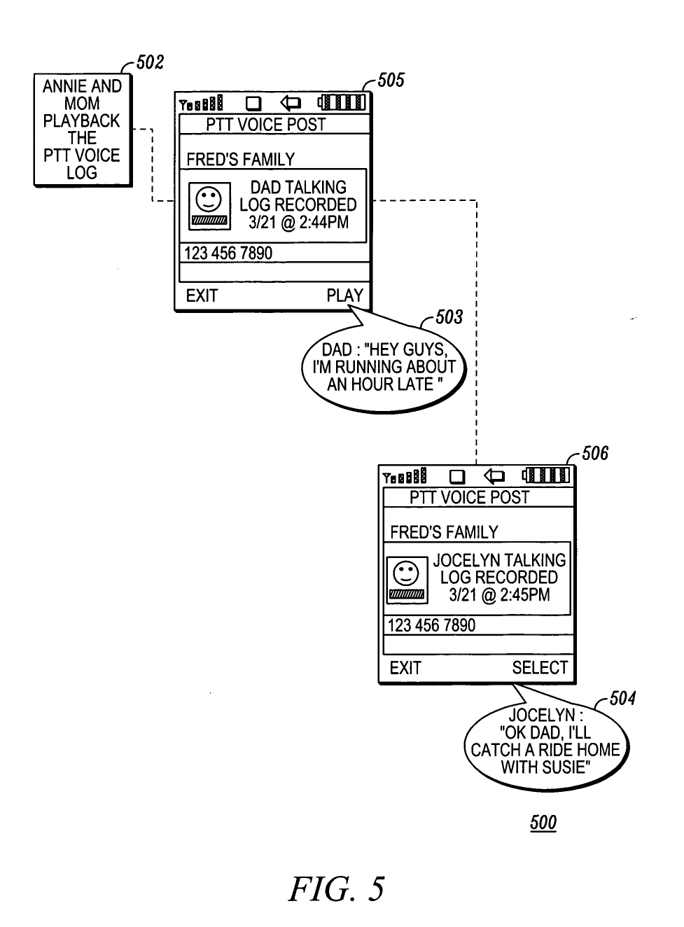

A schematic block diagram 500 illustrating playing of a portion of a PTT group call in accordance with some embodiments is illustrated in FIG. 5. In the schematic, the PTT group call participants Annie and Mom play back the PTT voice log which was recorded in FIG. 4. In step 502, each engages her PTT device to play back the recorded PTT group call. Accordingly, each PTT device audibly and sequentially plays back the messages 503, 504 which represent the conversational bursts of each participant in the PTT group call typically in chronological order. Simultaneous to the audio playback of a particular message, the PTT device indicates the participant who is currently speaking typically in a visual format on the PTT device. For example, as Dad's message which was recorded in step 404 of FIG. 4 is played back by the PTT device, Dad may be identified as the speaker such as by the display 505 of “Dad Talking Log Recorded 3/21 @ 2:44 pm”, for example. The next recorded message 504 in the PTT voice log, Jocelyn's response to Dad's message, is then played on the device while indicating 506 Jocelyn as the speaker.

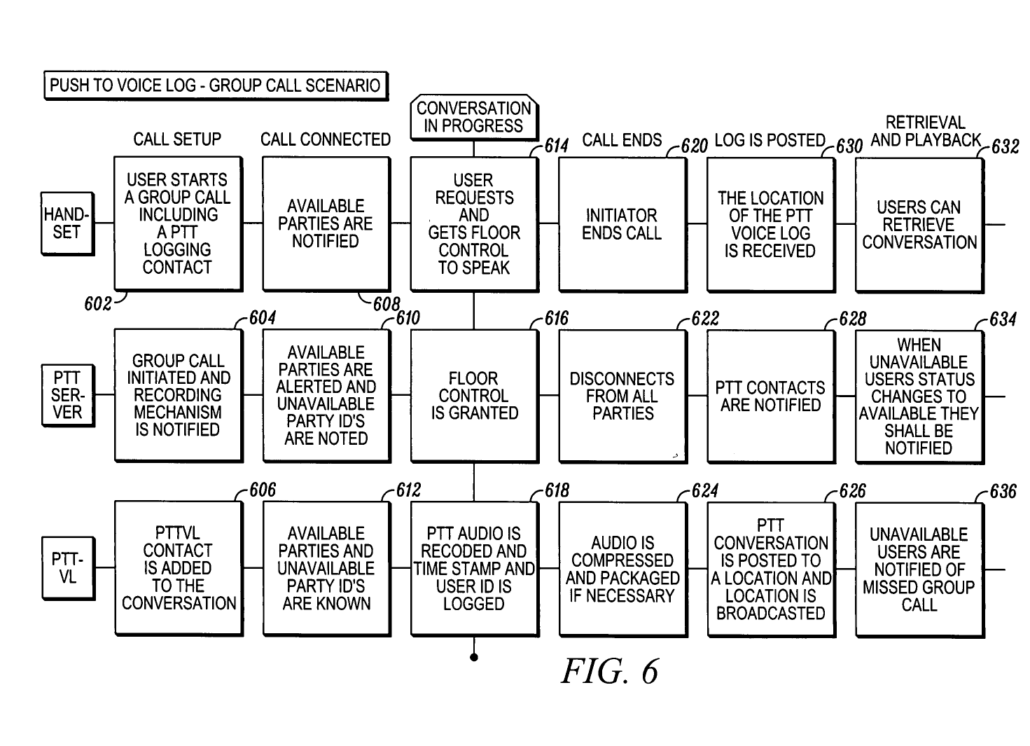

A flow diagram 600 illustrating a typical PTT group call scenario and engagement of a PTT handset, PTT server and PTTVL contact components of a PTT communication system in accordance with some embodiments is illustrated in FIG. 6. Steps 602, 604 and 606 illustrate how the PTT handset, PTT server and PTTVL contact facilitate setup of a PTT group call. In step 602, a PTT group participant, using his or her handset, initiates a PTT group call which includes at least one PTT group participant or PTT logging contact. In step 604, at the PTT server, the PTT group call is initiated and the recording mechanism is notified or engaged for operation. In step 606, the PTTVL contact is added as a participant of the PTT group call and engaged for operation during the PTT group call.

Steps 608, 610 and 612 illustrate how the PTT handset, PTT server, and PTTVL contact facilitate connection of the PTT group call. In step 608, the available parties or PTT group participants are notified that a PTT group call has been initiated. In step 610, the PTT server notifies the PTT group call participants and the unavailable PTT group members are noted. In step 612, at the PTTVL contact, the identities of the available PTT group call participants and the unavailable PTT group call participants are noted.

Steps 614, 616 and 618 illustrate engagement of the PTT handset, PTT server and PTTVL contact during the PTT group call. In step 614, each participant uses his or her handset to request floor control to speak messages to the other participants. In step 616, the PTT server grants the floor control to a participant. In step 618, the PTTVL contact records, identifies and timestamps the messages spoken by the participants into their PTT handsets. Steps 614, 616, and 618 continue while the conversation is in progress.

Steps 620, 622 and 624 illustrate engagement of the PTT handset, PTT server, and PTTVL contact upon ending of the PTT group call. In step 620, the originator of the PTT group call ends the call using his or her handset. In step 622, the PTT server disconnects from the handsets of the participants. In step 624, the PTTVL contact compresses and packages, if necessary, the audio and/or other media recorded during the call.

Steps 626, 628 and 630 illustrate engagement of the PTT handset, PTT server, and PTTVL contact in the posting of the PTT voice log. In step 626, the PTTVL contact posts the recorded PTT voice log to a location and broadcasts the location. In step 628, the PTT server notifies the PTT contacts, although there can be other mechanism to notify the available and unavailable group call participants. In step 630, the handsets of the participants receive the location of the PTT voice log.

Steps 632, 634 and 636 illustrate engagement of the PTT handset, PTT server, and PTTVL contact in the retrieval and playback of the recorded PTT voice log. In step 632, the PTT group members have the option of retrieving the recorded PTT voice log using their handsets. In step 634, when the status of each unavailable PTT group member changes from unavailable to available, the PTT server notifies the PTTVL contact that a previously unavailable PTT group member is now available. In step 636, the PTTVL contact notifies the previously unavailable PTT group member that the group call took place and is available for playback.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A push-to-talk voice log method, comprising:
designating group members for a push-to-talk group call;
implementing a push-to-talk group call between at least a first of said group members and a second of said group members and a push-to-talk voice log contact;
recording, by the push-to-talk voice log contact, said push-to-talk group call as a plurality of audio clips with associated metadata;
playing back said push-to-talk group call.

2. The method of claim 1 wherein said associated metadata comprises timestamp information.

3. The method of claim 2 wherein said timestamp information comprises a time of each of said plurality of audio clips.

4. The method of claim 2 further comprising sequencing said plurality of audio clips in chronological order.

5. The method of claim 1 wherein said associated metadata comprises ID information corresponding to a group member recorded.

6. The method of claim 5 wherein said ID information comprises a name of one of said group members.

7. The method of claim 5 wherein said ID information comprises a phone number of one of said participants of said push-to-talk group call.

8. The method of claim 1 further comprising notifying said first of said group members and said second of said group members that said push-to-talk group call is available for playback.

9. The method of claim 1 wherein said implementing a push-to-talk group call comprises implementing a push-to-talk group call between at least a first of said group members and a second of said group members, said first of said group members and said second of said group members being group participants of said push-to-talk group call and at least a third of said group members being at least one unavailable group member.

10. The method of claim 9 wherein said playing back said push-to-talk group call comprises playing back said push-to-talk group call to at least one of said group participants of said push-to-talk group call.

11. The method of claim 9 wherein said playing back said push-to-talk group call comprises playing back said push-to-talk group call to said at least one unavailable group member.

12. The method of claim 9 further comprising notifying said at least one unavailable group member that said push-to-talk group call was recorded and is available for playback.

13. The method of claim 1 wherein said recording comprises recording said push-to-talk group call as at least one picture.

14. The method of claim 1 wherein said recording comprises recording said push-to-talk group call as at least one video clip.

15. The method of claim 1 wherein said recording comprises recording said push-to-talk group call as at least one text message.

16. A Push-to-Talk (PTT) communication system comprising:
an originator communication device;
at least one participant communication device;
a network coupled to the originator communication device and the at least one participant communication device;
a PTT server coupled to the network for facilitating a PTT group call among the originator communication device and the at least one participant communication device by receiving a half-duplex message from an originator communication device and distributing it to the at least one participant communication device; and
a PTT voice log contact coupled to the PTT server 112 for recording the half-duplex message along with associated metadata.

17. The Push-to-Talk (PTT) communication system of claim 16 further comprising an interface between the PTT voice log contact and the network.

18. A Push-to-Talk (PPT) voice log contact comprising:
a receiving component for receiving a half-duplex message from a PTT server;
a recording component for recording the half-duplex message as a recording;
a timestamp and ID component for identifying the recording with identifying information;
a tagging component for tagging the recording with the identifying information;
a playback request component for receiving a request to play back the recording from a requesting device; and
a transmitting component for transmitting the recording and the identifying information to the requesting device.

19. The PTT voice log contact of claim 18 further comprising:
a notifying component for notifying at least one communication device that the recording has been made.

20. The PTT voice log contact of claim 18 further comprising:
a sequencing component for sequencing the recording within any other recordings of a single PTT group call.
